(19) United States
(12) Patent Application Publication
(10) Pub. No.: US 2013/0254874 A1
(43) Pub. Date: Sep. 26, 2013

(54) METHOD FOR PREVENTING INFORMATION DISPLAYED ON SCREEN FROM BEING VIEWED WITHOUT AUTHORIZATION AND DISPLAY DEVICE HAVING ANTI-VIEWING FUNCTION

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/528,034

(22) Filed: Jun. 20, 2012

(30) Foreign Application Priority Data
Mar. 23, 2012 (CN) 201210079575.8

(51) Int. Cl. G06F 21/22; G06K 9/62

(52) U.S. Cl. 726/17

(57) ABSTRACT

A computerized method prevents information displayed on a screen of a display device from being viewed by unauthorized persons. Images in front of the screen are captured at regular intervals using an image capturing device of the display device. Faces are recognized from each of the captured images using facial recognition technologies. Whether or not the screen is in a state of being viewed by one or more unauthorized persons is determined according to the faces recognized as such in each of the captured images. A predetermined anti-viewing display is displayed on the screen to prevent the information being displayed on the screen from being viewed by any unauthorized person, when the screen is determined to be in the state of being viewed by any unauthorized person.

### BACKGROUND

1. Technical Field

Embodiments of the present disclosure relate generally to display devices, and particularly to a method for preventing information displayed on a screen of the display device from being viewed without authorization and a display device having an anti-viewing function.

2. Description of Related Art

Devices, such as desk computers, panel computers, and smart mobile terminals have a display function to display information. For example, e-mails and pages of the Internet can be displayed. When the devices are used to edit or display confidential or personal contents, the user may want to prevent shoulder surfing. Therefore, there is room for improvement in the art.

### BRIEF DESCRIPTION OF THE DRAWINGS

FIG. 1 is a schematic block diagram of an exemplary embodiment of a display device including an anti-viewing system.

FIG. 2 is a schematic diagram illustrating one example of an image capturing device is installed on a screen of the display device of FIG. 1.

FIG. 3 and FIG. 4 are schematic diagrams illustrating two images captured by the image capturing device of FIG. 2.

FIG. 5 shows a schematic diagram of a predetermined mosaic display displayed on the screen.

FIG. 6 is a flowchart of one embodiment of a method for preventing information displayed on the screen of the display device from being viewed without authorization.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

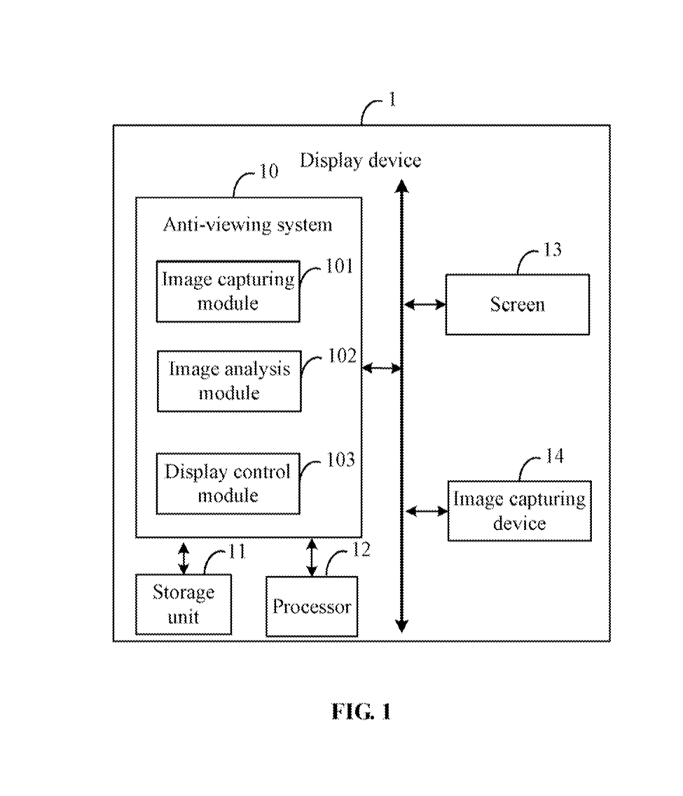

FIG. 1 is a schematic diagram of a display device 1 in accordance with an exemplary embodiment. The display device 1 includes an anti-viewing system 10, a storage unit 11, at least one processor 12, a screen 13, and an image capturing device 14. In one embodiment, the display device 1 may be, for example, a desktop computer including a display, a portable computer, or other similar device. FIG. 1 is one example of the display device 1, and the display device 1 can include more or fewer components than those shown in the embodiment, or have a different configuration of the components.

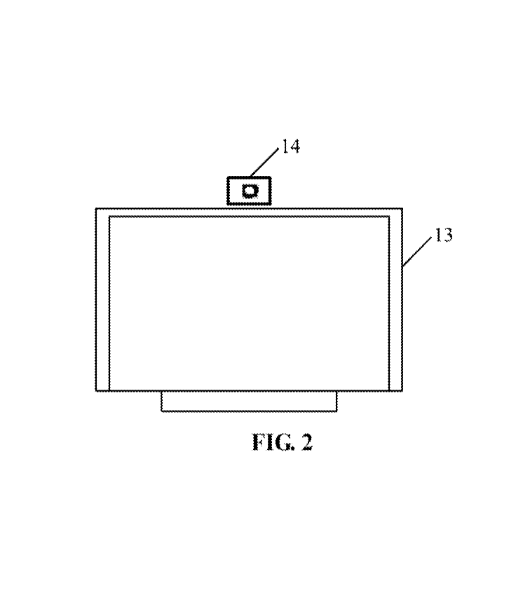

Referring to FIG. 2, the image capturing device 14 may be installed above the screen 13, and capture images in front of the screen 13. The captured images are analyzed by the anti-viewing system 10.

The anti-viewing system 10 may include a plurality of programs in the form of one or more computerized instructions stored in the storage unit 11 and executed by the at least one processor 12 to perform operations of the electronic device 1. In the embodiment, the anti-viewing system 10 includes an image capturing module 101, an image analysis module 102, and a display control module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The image capturing module 101 controls the image capturing device 14 to capture images in front of the screen 13 at regular intervals, such as every two or three seconds.

The image analysis module 102 analyzes each of the captured images using facial recognition technologies, and determines whether the screen 13 is being viewed by other unauthorized person(s) according to the analysis of the images.

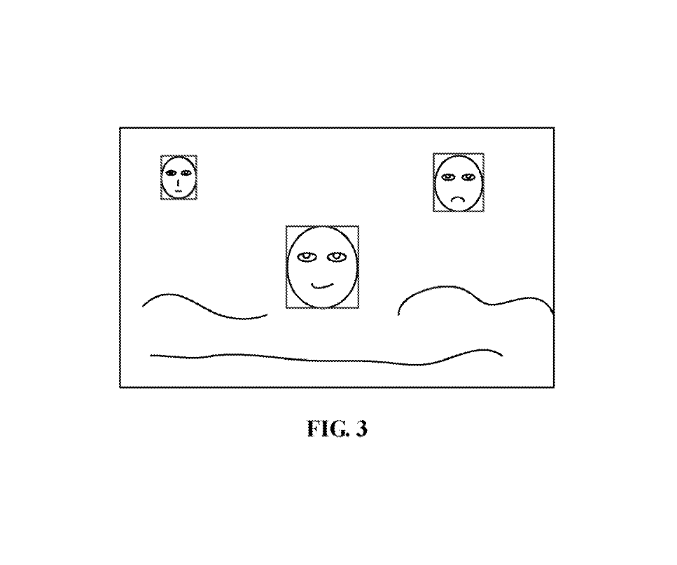

In one embodiment, the image analysis module 102 detects how many faces are recognized from a current image captured by the image capturing device 14. If more than one face is recognized as being included in the current image, the screen 13 is determined to be in the state of being overlooked or viewed by someone unauthorized. In one example, as shown in FIG. 3, three faces are recognized from the current image captured by the image capturing device 14, and the screen 13 is determined to be in the state of being viewed by at least two unauthorized persons.

Additionally, if only one face is recognized from the current image, the image analysis module 102 compares the face with one or more preset and authorized facial images stored in the storage unit 11. If none of the authorized facial images matches with the face in the current image, the screen 13 is also in the state of being viewed by at least one unauthorized person. The one or more authorized facial images may be predetermined by a user of the electronic device 1, and stored in the storage unit 11.

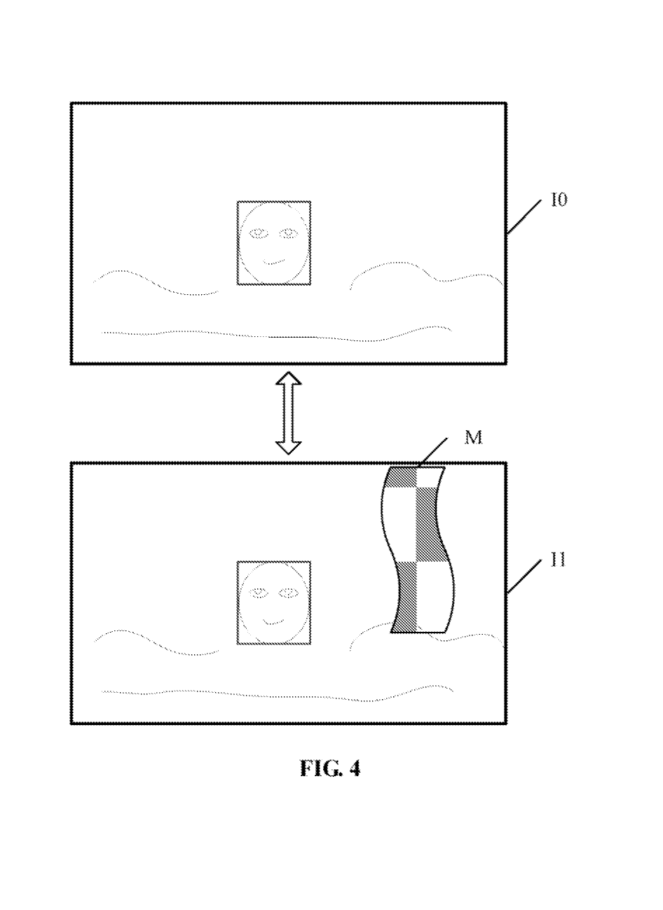

If at least one of the authorized facial images matches with the only face found in the current image, the image analysis module 102 further determines whether a background of the current image captured by the image capturing device 14 matches with a predetermined standard background. When the background of the current image does not match with the standard background, the screen 13 is regarded as being viewed by one or more unauthorized persons. In the embodiment, the image analysis module 102 may acquire the standard image (e.g., I0 of FIG. 4) from the storage unit 11, and locate a background area of the standard image and a background area of the current image (e.g., I1 of FIG. 4). Then, the image analysis module 102 compares the background area of the current image with the background area of the standard image (standard background), to determine whether the background area of the current image matches with the background area of the standard image according to the comparison between the current image and the standard image. In one example as shown in FIG. 4, the background area of the current image I1 has a region M that is different from the background area of the standard image I0, so that the screen 13 is regard as being viewed by someone unauthorized.

In another embodiment, the image analysis module 102 may locate all the faces found in the current image, and then compare each of the faces with the one or more authorized facial images. When one or more of the faces found in the image does not match with any of the one or more authorized facial images, the screen 13 is determined to be viewed by one or more unauthorized persons. If each of the faces matches with at least one of the one or more authorized facial images, the screen 13 is not in being viewed by any unauthorized person, that is, in a state of being properly viewed. Thus, the user can view the screen 13 with other people allowed by the user.

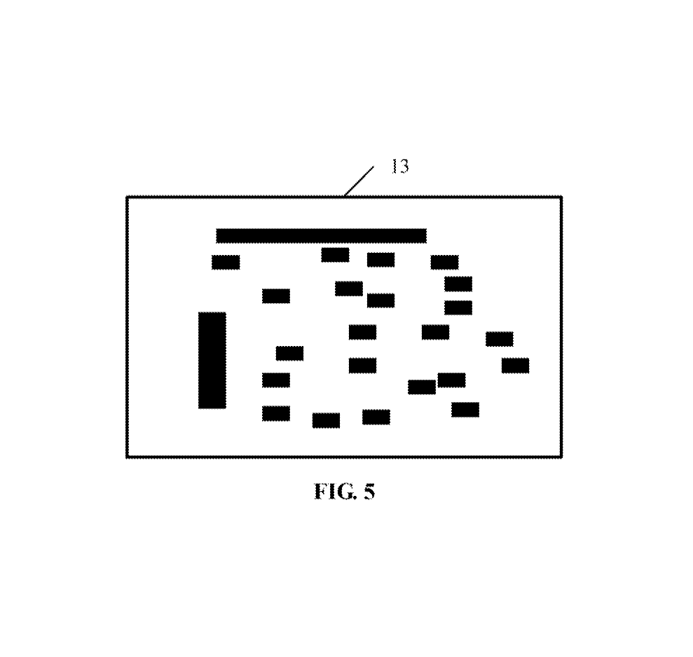

The display control module 103 controls the screen 13 to display a predetermined anti-viewing display to prevent information being displayed on the screen 13 from being viewed by the unauthorized person(s) when the screen 13 is determined to be viewed by any unauthorized person. For example, a mosaic display as shown in FIG. 5 may be displayed on the screen 13, when the screen 13 is being viewed by one or more unauthorized person.

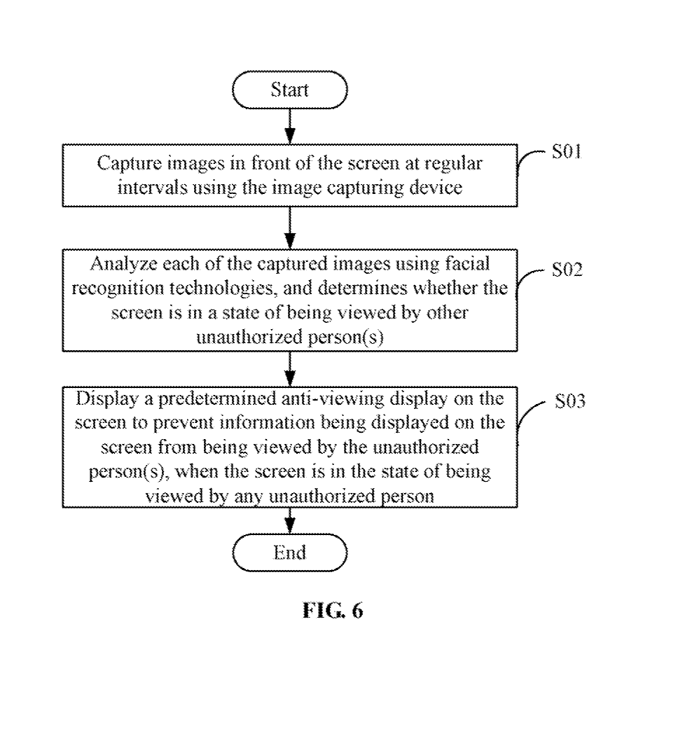

FIG. 6 is a flowchart of one embodiment of a method for preventing the screen 13 of the display device 1 from being viewed without authorization. Depending on the embodiment, additional steps may be added, others removed, and the ordering of the steps may be changed.

In step S01, the image capturing module 101 captures images in front of the screen 13 at regular intervals using the image capturing device 14.

In step S02, the image analysis module 102 analyzes each of the captured images using facial recognition technologies, and determines whether the screen 13 is in a state of being viewed by other unauthorized person(s) according to the analysis of the images. Details of analysis of the captured images are provided above.

In step S03, the display control module 103 displays a predetermined anti-viewing display (e.g., the mosaic display of FIG. 5) on the screen 13 to prevent information being displayed on the screen 13 from being viewed by the unauthorized person(s), when the screen 13 is determined to be in the state of being viewed by any unauthorized person.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for preventing information displayed on a screen of a display device from being viewed without authorization, the method comprising:
capturing images in front of the screen at regular intervals using an image capturing device of the display device;
recognizing faces from each of the captured images using facial recognition technologies;
determining whether the screen is in a state of being viewed by other unauthorized person(s) according to the recognized faces included in each of the captured images; and
displaying a predetermined anti-viewing display on the screen to prevent the information being displayed on the screen from being viewed by the unauthorized person(s), when the screen is determined to be in the state of being viewed by any unauthorized person.

2. The method according to claim 1, wherein the determining step comprises:
detecting how many faces are recognized from a current image captured by the image capturing device; and
regarding that the screen is being viewed by at least one unauthorized person when more than one face is recognized from the current image.

3. The method according to claim 2, wherein the determining step further comprises:
in response to only one face being recognized from the current image, comparing the only face with one or more preset authorized facial images; and
regarding the screen as being viewed by at least one unauthorized person, when none of the authorized faces matches with the only face.

4. The method according to claim 3, wherein the determining step further comprises:
determining whether a background of the current image captured by the image capturing device matches with a predetermined standard background, when at least one of the authorized facial images matches with the only face; and
regarding that the screen as being viewed by one or more unauthorized persons, when the background of the current image does not match with the standard background.

5. The method according to claim 1, wherein the determining step comprises:
locating all faces found in the current image;
comparing each of the located faces with the one or more authorized facial images; and
regarding that the screen as being viewed by at least one unauthorized person when at least one of the located faces does not match with any of the authorized facial images, or regarding that the screen is not viewed by any unauthorized person when each of the located faces matches with at least one of the authorized facial images.

6. A display device, comprising:
a screen;
an image capturing device;
a storage unit that stores one or more preset authorized facial images and a preset standard image captured by the image capturing device;
at least one processor; and
one or more programs stored in the storage unit and executed by the at least one processor, the one or more programs comprising:
an image capturing device that captures images in front of the screen at regular intervals using the image capturing device;
an image analysis module that recognizes faces from each of the captured images using facial recognition technologies, and determines whether the screen is being viewed by other unauthorized person(s) according to the recognized faces included in each of the captured images; and
a display control module that displays a predetermined anti-viewing display on the screen to prevent information being displayed on the screen from being viewed by the unauthorized person(s), when the screen is determined to be in the state of being viewed by any unauthorized person.

7. The display device according to claim 6, wherein the image analysis module detects how many faces are recognized from a current image captured by the image capturing device, and determines that the screen is being viewed by at least one unauthorized person when more than one face is recognized from the current image.

8. The display device according to claim 7, in response to only one face being recognized from the current image, wherein the image analysis module compares the only face with one or more preset authorized facial images, and determines that the screen is being viewed by at least one unauthorized person when none of the authorized faces matches with the only face.

9. The display device according to claim 8, wherein the image analysis module determines whether a background of the current image captured by the image capturing device matches with a predetermined standard background when at least one of the authorized facial images matches with the only face, and determines that the screen is being viewed by one or more unauthorized persons when the background of the current image does not match with the standard background.

10. The display device according to claim 6, wherein the image analysis module locates all faces found in the current image, compares each of the located faces with the one or more authorized facial images, and determines that the screen is in the state of being viewed by at least one unauthorized person when at least one of the located faces does not match with any of the authorized facial images, or determines that the screen is not viewed by any unauthorized person when each of the located faces matches with at least one of the authorized facial images.
